(19) United States
(12) Patent Application Publication
(10) Pub. No.: US 2026/0273539 A1
(43) Pub. Date: Sep. 17, 2026

(54) Rotor Disc Device for Repelling Grinding Media for an Agitator System as Well as an Agitator System for Mechanical Activation and/or Grinding of Organic and/or Inorganic Substances and/or Mixtures of Substances in Chemical, Pharmaceutical, Food and/or Building Materials Applications

(71) Applicant: Netzsch-Feinmahltechnik GmbH, Selb (DE)

(72) Inventors: Xavier Costa, Sant Cugat del Vallès (ES); Mario Stolz, Selb (DE); Claus Simon, Alzenau (DE)

(21) Appl. No.: 19/554,838

(22) Filed: Mar. 3, 2026

(30) Foreign Application Priority Data
Mar. 14, 2025 (DE) 10 2025 109 776.3

(51) Int. Cl. B02C 17/16; B01F 27/052; B01F 27/07; B01F 27/115; B01F 27/73; B01F 33/80; B01F 33/83; B01F 101/00; B01F 101/06; B01F 101/22

(52) U.S. Cl. CPC B02C 17/161; B01F 27/052; B01F 27/071; B01F 27/115; B01F 27/73; B01F 33/8305; B01F 33/83613; B01F 2101/06; B01F 2101/22; B01F 2101/2204; B01F 2215/0431

(57) ABSTRACT

A rotor disc device for repelling grinding media for an agitator system, the rotor disc device including: a base disc, which has a disc thickness and a plurality of slot-shaped recesses, wherein the plurality of slot-shaped recesses each extend along the entire disc thickness, and wherein the plurality of slot-shaped recesses each have a slot width of about 90% or less of a diameter of the grinding media to be repelled, wherein the slot width is aligned perpendicular to the disc thickness; and a form-fitting connecting means, which is firmly connected to the base disc and is designed for rotationally fixed mounting on a stirrer shaft of an agitator system. Furthermore, the present invention creates an agitator system with such a rotor disc device.

### TECHNICAL FIELD

The present invention relates to a rotor disc device for repelling grinding media for an agitator system and an agitator system with such a device.

### BACKGROUND

In mechanochemistry, the aim is to transform material through mechanical activation, especially through shear and normal stresses, into an active state in which the material is particularly reactive. Mechanochemistry is thus understood to mean the mechanical activation of chemical reactions. This can be attributed, among other things, to a destabilisation of the atomic bond and changes in crystal structures. The reactions are also promoted by the grinding the particles and the emergence of new reactive surfaces. Compared to previous reactions, mechanochemistry does not require solvents and heat treatment, which can have a negative influence on the environment. Mechanical activation can be carried out in a so-called dry process. Alternatively, a process fluid such as a solvent for example can be used in a so-called wet process.

In the prior art, vibrating mills and planetary ball mills as well as extrusion processes have hitherto been used for this purpose. Diaphragms are usually used in the latter to prevent the balls from flowing out at a flow outlet. These diaphragms are usually attached to the housing of the ball mill directly in front of the outlet and usually do not rotate with the shaft.

A general structure of an agitator bead mill known from practice is described in DE 10 2013 021 756 A1. This known agitator bead mill comprises a grinding chamber surrounded by a housing, into which grinding stock to be crushed is fed through a product inlet. In the grinding chamber, grinding media and an agitator with a rotor are contained, the rotation of which ensures the intensive movement of the grinding media, as a result of which the grinding stock to be crushed is crushed. At the axial end of the rotor, there is a separation device which in particular jointly rotates and which serves to separate the grinding media and the grinding stock to be ground to be still further on the one hand and on the other hand the finish-ground grinding stock and is located upstream of a product outlet in the housing. The separation device is formed, for example, by a bladed rotor body which rotates together with the rotor and is designed and operated in such a way that it should not permit the passage of grinding media, whereby the separation device, especially due to the size of the intermediate spaces between the blades of the bladed rotor body and the rotary movement of the bladed rotor body, repels the grinding media and thus blocks it at the passage through the separation device from the grinding chamber into the product outlet.

Furthermore, DE 10 2012 013 279 A1 describes an agitator bead mill with a separation system, wherein the separation system has a basket that rotates with the agitator shaft, which essentially retains the grinding media in the grinding chamber.

The disadvantage of the known agitator bead mills is that there can be a high pressure drop at the product outlet and/or a small through-flow is provided. Furthermore, the rotor can be blocked by fillers or filler materials, such as barite or lime. In addition, there are often problems with scaling and/or wear on the known agitator bead mills.

The problem of the present invention is to provide a rotor disc device as well as an agitator system which can improve the operating conditions.

### SUMMARY

According to the invention, this problem is solved in each case by the subject-matter of the claims.

According to a first aspect of the invention, a rotor disc device for repelling grinding media is provided for an agitator system. The rotor disc device comprises a base disc that has a disc thickness and a plurality of slot-shaped recesses. The plurality of slot-shaped recesses extend along the entire thickness of the disc. The plurality of slot-shaped recesses each have a slot width of about 90% of the diameter of the grinding media to be repelled or less. The slot width is aligned perpendicular to the thickness of the disc. In addition, the rotor disc device includes a form-fitting connecting means which is firmly connected to the base disc and is designed for rotationally fixed mounting on a stirrer shaft of an agitator system.

According to a second aspect of the invention, an agitator system is provided for the mechanical activation and/or grinding of organic and/or inorganic substances and/or mixtures of substances in chemical, pharmaceutical, food and/or building applications. The agitator system comprises a container for holding grinding media as well as a substance and/or substance mixture to be activated and/or to be ground. The agitator system also comprises a stirrer shaft which is mounted in the container and is rotatable in relation to the container. Furthermore, the agitator system comprises a rotor disc device according to the first aspect of the invention, wherein the form-fitting connecting device is mounted on the stirrer shaft in a rotationally fixed manner.

An idea underlying the present invention is to provide a rotor disc device or slot-shaped disc that rotates with the stirrer shaft of the agitator system. The base disc has a plurality of slot-shaped recesses or gaps so that the substance and/or substance mixture to be activated and/or ground can flow through the rotor disc device. Preferably, the base disc has as many slot-shaped recesses as possible, so that a large area through a flow can take place is provided in relation to the base disc. The size of the slot-shaped recesses or gaps can depend on the dimensions, especially the diameter, of the grinding media.

The base disc is essentially formed around an axis of rotation of the base disc. In the sense of the present invention, round essentially also includes a polygonal formation, the outline of which can be approximately described as round. In particular, a corner of a polygonal base disc, which can also be described as essentially round, can have an angle of about 165° to about 180°. The disc thickness can be measured on the base disc parallel to the axis of rotation.

In the sense of the present invention, the mechanical activation of organic and/or inorganic substances and/or substance mixtures in chemical, pharmaceutical, food and/or building materials applications refers to the effect of mechanical loads on the substance and/or the substance mixture, so that chemical reactions, in particular reactions affecting polymers, are initiated or activated. For example, such mechanical loads can lead to the depolymerisation of polymers. In particular, no solvents or suchlike are used in mechanical activation. This means that the mechanical activation for the mechanochemical effect is carried out in a dry container.

The rotor disc device is arranged in the container in such a way that the substance and/or substance mixture to be activated and/or to be ground flows through the plurality of slot-shaped recesses and cannot flow past the rotor disc device. In the case of the agitator system according to the invention, a differential velocity between the grinding media or activation bodies and the rotor disc device can be significantly lower than in conventional agitator bead mills with a fixed diaphragm. The grinding media and/or the rotor disc device according to the invention thus wear less and/or more slowly. Depending on the substance and/or substance mixture, grinding media can have a grinding effect or have a mechanochemically activating effect, or both.

An advantage of the present invention is that a bladed rotor body or basket known from the prior art described above can be omitted. More space can thus be created for additional stirrer devices, for example an additional one to three, especially two, stirrer devices, in the existing agitator bead mills. The additional stirrer devices can provide a higher energy input into the substance and/or substance mixture to be activated and/or ground. Furthermore, a grinding zone can be enlarged and/or a grinding chamber volume can be used more efficiently.

A further advantage is that much less energy is required due to the rotor disc device according to the invention. The rotor disc device of the invention can reduce power consumption and overcome problems with fillers that can block the known bladed rotor body or basket. In addition, a pressure drop and thus operating costs can be reduced.

Advantageous embodiments and developments result from the sub-claims related to the independent claims as well as from the description making reference to the figures.

According to an embodiment of the present invention, the slot width is about 50% to about 80% of the diameter of the grinding media to be repelled. With this slot width, a wear-related reduction in the diameter of the grinding media can already be taken into account, so that the grinding media can be used for longer in the agitator system and do not pass through the slot-shaped recesses despite wear. In particular, the plurality of slot-shaped recesses each have a slot width of about 60% of the diameter of the grinding media to be repelled.

According to a further embodiment of the present invention, the base disc has a coating to reduce the wear on the rotor disc device. The coating can be made of ceramic, for example.

According to a further embodiment of the present invention, the form-fitting connecting means is designed as a tongue-and-groove connection, which can be mounted on the stirrer shaft in a rotationally fixed manner. This means that the rotor disc device can be easily pushed onto the stirrer shaft and is also connected to it in a rotationally fixed manner. The tongue-and-groove connection can compensate for manufacturing tolerances in the axial direction and can be axially fixed with the aid of a suitably dimensioned spacer sleeve.

According to a further embodiment of the present invention, the plurality of slot-shaped recesses is arranged in a common circle around an axis of rotation of the base disc. In the arrangement described here, the orientation or extension of the slot-shaped recesses intrinsically remains open.

According to a development of the present invention, the plurality of slot-shaped recesses is arranged uniformly distributed on the common circle. In other words, the plurality of slot-shaped recesses can be arranged uniformly distributed in a circumferential direction of the base disc. For example, at least two of the slot-shaped recesses can extend along the common circle.

According to a further embodiment of the present invention, the plurality of slot-shaped recesses are each aligned in a radial direction of the base disc. This means that the plurality of slot-shaped recesses can each extend in the radial direction of the base disc. For example, at least two of the plurality of slot-shaped recesses can be arranged sequentially in the radial direction and extend in the radial direction.

According to a further development of the present invention, the plurality of slot-shaped recesses are aligned parallel to each other. The slot-shaped recesses can be arranged in parallel at a uniform distance from each other.

According to a further embodiment of the present invention, the plurality of slot-shaped recesses are arranged concentrically with respect to an axis of rotation of the base disc. For example, the plurality of slot-shaped recesses can be arranged in a common circle around an axis of rotation of the base disc and concentrically with respect to the axis of rotation.

According to a further embodiment of the present invention, the plurality of slot-shaped recesses each widen in a direction of flow of the substance and/or substance mixture to be activated. In this way, the slot-shaped recesses are able to clog less and/or more slowly, since particles or solids present in the slot-shaped recesses can flow out more easily through the widening cross-section. The direction of flow corresponds for example to the axis of rotation of the base disc or the stirrer shaft. The plurality of slot-shaped recesses can each have an opening angle in a range of about 0.1° to about 60°, preferably in a range of about 10° to about 30°.

According to a further embodiment of the present invention, the rotor disc device is arranged, viewed in a direction of flow of the substance and/or substance mixture to be activated, at the last position inside the container on the stirrer shaft.

For example, the stirrer shaft can be motor-driven. Preferably, the stirrer shaft can be driven by a motor arranged outside the container, wherein the motor is designed and can be operated at a variable speed.

Optionally, the agitator system can have an inlet opening and an outlet opening, wherein the inlet opening and outlet opening are arranged on opposite sides of the container. A preliminary crushing element, for example, can be arranged, in particular attached, in the area of the inlet opening. The rotor disc device can be arranged at the outlet opening, for example.

According to a further embodiment of the present invention, the agitator system also comprises at least one disc-like agitator device, which is mounted rotationally fixed on the stirrer shaft by means of the same form-fitting means as the rotor disc device. Production costs and/or assembly time can thus be saved. For example, the at least one disc-like agitator device and the rotor disc device can be axially fixed in relation to the container by means of a spacer sleeve or spacer bushing.

For example, the stirrer shaft can be one-piece or multi-part. Alternatively, or in addition, the stirrer shaft can be designed as a solid shaft or as a hollow shaft. Optionally, a plurality of disc-like agitator devices can be mounted on the stirrer shaft, which are arranged in series on the stirrer shaft. For example, the plurality or number of the several disc-like agitator devices can be 4 to 20, especially 7 to 15. Alternatively, or in addition, the plurality or number of disc-like agitator devices can depend on the diameter of the grinding media and a ratio of length to diameter of the container.

Optionally, each disc-like agitator device can comprise a plurality of striking units, which are arranged uniformly distributed in a circumferential direction of the disc-like agitator device. In this way, the substance and/or the substance mixture to be activated and/or ground can be activated essentially uniformly by the plurality of striking units when the disc-like agitator device rotates. Furthermore, a plurality of striking units can each comprise an extension arm, which is arranged between the disc-like agitator device and an activation surface.

According to a further embodiment of the present invention, the tongue-and-groove connection is axially fixed with respect to the container with the aid of a spacer sleeve. For example, the tongue-and-groove connection can be clamped with the aid of the spacer sleeve between the container and an agitator device of the agitator system. The spacer sleeve can be mounted on the stirrer shaft; in other words the spacer sleeve can radially delimit the stirrer shaft.

According to a further embodiment of the present invention, the grinding media are essentially spherical in shape, wherein a spherical equivalent diameter of the grinding media is in the range of about 1 mm to about 15 mm. The grinding media can be made of steel, ceramic, plastic, composite, reactive material such as palladium, and/or a combination of materials. In addition, the grinding media can be coated with one of the aforementioned materials or a material combination thereof.

The direction of flow corresponds for example to the axis of rotation of the disc-like agitator device or the stirrer shaft. The container can have a length-to-diameter ratio in a range of about 2 to about 5. Preferably, the container is designed cylindrical. For example, the rotation axis of the stirrer shaft can be aligned essentially horizontal in the container. In particular, the stirrer shaft can be fitted concentrically in a rotatable manner in the container.

In addition, the container can be fixed in relation to an environment. Optionally, the container can have a coating on its inside. The coating can contain a reactive material, such as palladium for example. The coating can improve the mechanochemical reaction effect in the container or quite generally make it possible.

The above embodiments and developments can be arbitrarily combined with each other, insofar as feasible. In particular, all the features of the device can be transferred to the associated method, and vice versa. Further possible embodiments, developments and implementations of the invention also include, though not explicitly mentioned, combinations of features of the invention described previously or in the following with regard to the examples of embodiment. In particular, the person skilled in the art will also add individual aspects as improvements or additions to the respective basic form of the present invention.

### BRIEF DESCRIPTION OF DRAWINGS

The present invention is explained in greater detail below with the aid of examples of embodiment making reference to the appended figures in the drawings. In the figures:

FIG. 1 shows a diagrammatic sectional view of an agitator system for the mechanical activation of organic and/or inorganic substances and/or substance mixtures in chemical, pharmaceutical, food and/or building materials applications according to an embodiment of the invention;

FIG. 2A shows a diagrammatic front view of a rotor disc device for repelling grinding media for an agitator system according to a further example of embodiment of the invention, wherein the plurality of slot-shaped recesses are arranged concentrically;

FIG. 2B shows a diagrammatic front view of a rotor disc device for repelling grinding media for an agitator system according to a further example of embodiment of the invention, wherein the plurality of slot-shaped recesses are aligned in parallel;

FIG. 2C shows a diagrammatic front view of a rotor disc device for repelling grinding media for an agitator system according to a further example of embodiment of the invention, wherein the plurality of slot-shaped recesses are aligned in the radial direction; and

FIG. 3 shows a diagrammatic sectional view of a detail of a rotor disc device for repelling grinding media for an agitator system according to a further example of embodiment of the invention, wherein the plurality of slot-shaped recesses widen.

In the figures of the drawing, identical, functionally identical or identically acting elements, features and components are denoted-unless stated otherwise-are each provided with the same reference numbers.

### DETAILED DESCRIPTION

Although specific embodiments and developments are presented and described in the present case, the skilled person will prefer that a plurality of alternative and/or similar embodiments can replace the specific embodiments presented and described, without departing from the scope of the present invention. In general, this application is intended to cover all modifications or changes to the specific examples of embodiment described herein.

The appended figures are intended to provide a further understanding of embodiments of the invention and serve in connection with the description of the explanation of principles and concepts of the invention. Other embodiments and many of the advantages mentioned arise with regard to the drawings. The drawings are to be understood only as diagrammatic drawings and the elements of the drawings are not necessarily shown true to scale with respect to each other. Directional terminology such as “up”, “down”, “left”, “right”, “above”, “under”, “horizontal”, “vertical”, “front”, “back” and similar indications are used solely for explanatory purposes and do not serve to limit the generality to specific embodiments as shown in the figures.

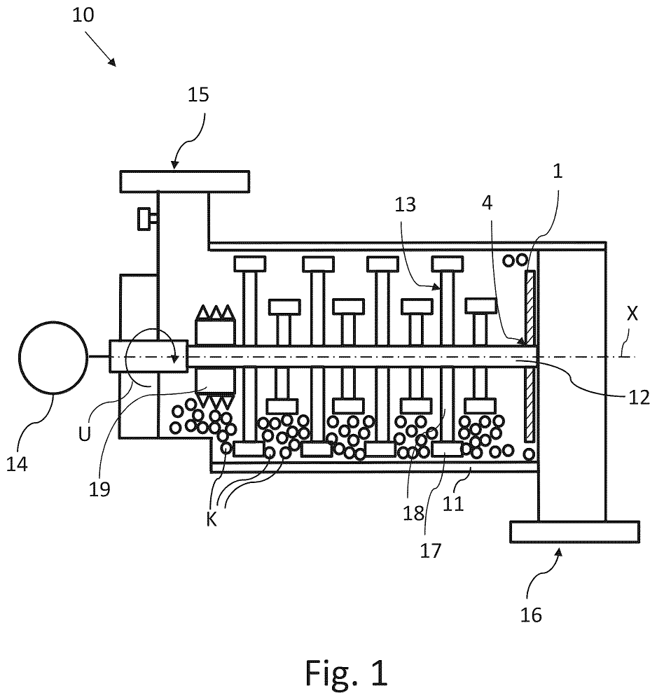

FIG. 1 shows a schematic sectional view of an agitator system 10 for the mechanical activation of organic and/or inorganic substances and/or substance mixtures in chemical, pharmaceutical, food and/or building materials applications according to an example embodiment of the invention.

Agitator system 10 comprises, for example, a container 11 for receiving a grinding media K as well as a substance and/or substance mixture to be activated and/or ground, a stirrer shaft 12, a plurality of disc-like agitator devices 13, a motor 14, an inlet opening 15, an outlet opening 16, and a preliminary crushing element 19.

In addition, agitator system 10 comprises, by way of example, a rotor disc device 1 for repelling grinding media K for an agitator system 10. Rotor disc device 1 comprises a base disc 2 which has a disc thickness T and a plurality of slot-shaped recesses 3. The plurality of slot-shaped recesses 3 each extend along entire disc thickness T. The plurality of slot-shaped recesses 3 each have a slot width B of about 90% or less of a diameter of grinding media K to be repelled. Slot width B is aligned perpendicular to disc thickness T, as shown in FIG. 3.

Furthermore, rotor disc device 1 comprises a form-fitting connecting means 4, which is firmly connected to a base disc 2 and is designed for rotationally fixed mounting on a stirrer shaft 12 of an agitator system 10.

As illustrated by way of example in FIG. 1, disc-like agitator devices 13 can be arranged in series on stirrer shaft 12. For example, the plurality or number of the several disc-like agitator devices can be 4 to 20, especially 7 to 15. Alternatively, or in addition, the plurality or number of disc-like agitator devices 13 can be dependent on the diameter of grinding media K and a ratio of length to diameter of container 11.

Each disc-like agitator device 13 is mounted on stirrer shaft 12 in a rotationally fixed manner and coupled with a plurality of striking units 17. The plurality of striking units 17 each comprise an extension arm 18 and a head area with an activation surface for interaction with grinding media K. The plurality of striking units 17 is attached radially from the exterior relative to an axis of rotation X of disc-like agitator device 13 to disc-like agitator device 13. In particular, the plurality of striking units 17 can project relative to axis of rotation X of disc-like agitator device 13 radially or in the radial direction from disc-like agitator device 13.

Adjacent striking units 17 can for example each be arranged with an offset of 5° to 90° to one another on stirrer shaft 12. The activation areas can thus be increased and/or the distances between adjacent disc-like agitator devices 13 can be reduced without striking units 17 of adjacent devices 1 colliding with one another. Alternatively, striking units 17 can be arranged in alignment with each other on stirrer shaft 12.

Optionally, disc-like agitator device 13 can be mounted rotationally fixed on stirrer shaft 12 with the aid of the same form-fitting connecting means 4 as rotor disc device 1. For example, at least one disc-like agitator device 13 and rotor disc device 1 can be axially fixed in relation to container 11 by means of a spacer sleeve 17 or spacer bushing.

Stirrer shaft 12 is mounted in container 11 and can be rotated in relation to container 11. A radial outer end of respective striking unit 3 can have a distance to container 11 in the range of two to ten times the diameter of grinding media K. For example, grinding media K can be essentially spherical in shape, as shown diagrammatically in FIG. 1, wherein a spherical equivalent diameter of grinding media K is in the range of about 1 mm to about 15 mm. Grinding media K can be made of steel, ceramic, plastic, composite material, and/or reactive material such as palladium. Alternatively, or in addition, grinding media K can be made of a material combination of the aforementioned materials. Moreover, grinding media K can be coated with one of the aforementioned materials or a material combination thereof.

Furthermore, depending on the activation reaction, a movement of grinding media K, which leads to an impact stress and/or shear stress, can be adjusted.

Motor 14 can for example be arranged outside container 11 and stirrer shaft 12 can be driven in a motorised manner. Motor 14 can be designed and operated at a variable speed.

For example, inlet opening 15 and outlet opening 16 can be arranged on opposite sides of container 11. Preliminary crushing element 19 can be arranged, or in particular attached, in the area of inlet opening 15, for example.

The spacer bushing can be mounted between adjacent disc-like agitator devices 13 or between rotor disc device 1 and a disc-like agitator device 13 on stirrer shaft 12. The direction of flow corresponds for example to axis of rotation X of disc-like agitator device 2 or stirrer shaft 12.

Container 11 can have a length-to-diameter ratio in a range of about 2 to about 5. Preferably, container 11 is designed cylindrical. Axis of rotation X of stirrer shaft 12 can for example be essentially horizontal in container 11. In particular, stirrer shaft 12 can be fitted concentrically rotatable in container 11. In addition, container 11 can be fixed in relation to an environment. Optionally, container 11 can have a coating on its inner side. The coating can contain a reactive material, such for example palladium. The mechanochemical reaction effect in container 11 can be improved by the coating or even make it possible.

For example, rotor disc device 1 can be arranged, viewed in a direction of flow of the substance and/or substance mixture to be activated, at the last position inside container 11 on stirrer shaft 12.

If form-fitting connecting means 4 is designed for example as a tongue-and-groove connection, the tongue-and-groove connection can be axially fixed with respect to container 11 with the aid of a spacer sleeve. For example, the tongue-and-groove connection can be clamped with the aid of the spacer sleeve between container 11 and an agitator device 13 of agitator system 10. The spacer sleeve can be mounted on stirrer shaft 12, in other words the spacer sleeve can radially delimit stirrer shaft 12.

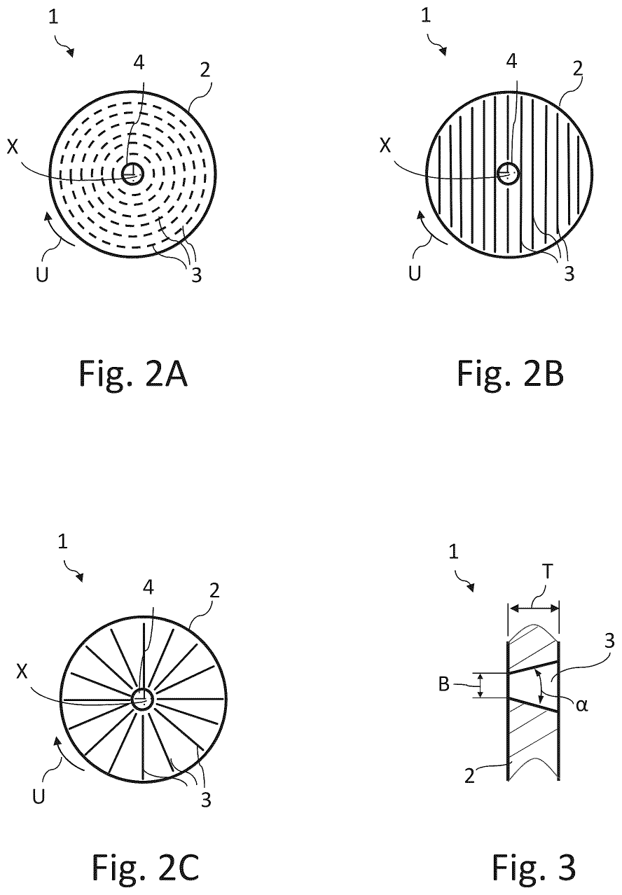

FIG. 2 shows a diagrammatic front view of a rotor disc device 1 for repelling grinding media K for an agitator system 10 according to a further example of embodiment of the invention, wherein the plurality of slot-shaped recesses 3 are arranged concentrically.

Rotor disc device 1 comprises a base disc 2, which has a disc thickness T and a plurality of slot-shaped recesses 3. The plurality of slot-shaped recesses 3 each extend along entire disc thickness T. The plurality of slot-shaped recesses 3 each have a slot width B of about 90% or less of a diameter of grinding media K to be repelled. Slot width B is aligned perpendicular to disc thickness T, as shown in FIG. 3.

Furthermore, rotor disc device 1 comprises a form-fitting connecting means 4 which is firmly connected to base disc 2 and is designed for rotationally fixed mounting on a stirrer shaft 12 of an agitator system 10.

Base disc 2 is essentially formed around an axis of rotation X. Disc thickness T can be measured at base disc 2 parallel to axis of rotation X. Optionally, base disc 2 can have a coating to reduce wear on rotor disc device 1. The coating can be made of ceramic, for example.

Slot width B can preferably be about 50% to about 80% of the diameter of grinding media K to be repelled. In particular, the plurality of slot-shaped recesses 3 each have a slot width B of about 60% of the diameter of grinding media K to be repelled.

For example, form-fitting connecting means 4 can be designed as a tongue-and-groove connection which can be mounted on stirrer shaft 12 in a rotationally fixed manner.

As shown by way of example in FIG. 2A, the plurality of slot-shaped recesses 3 can be arranged in a common circle around an axis of rotation X of base disc 2. Furthermore, the plurality of slot-shaped recesses 3 can be arranged uniformly distributed on the common circle. In other words, the plurality of slot-shaped recesses 3 can be arranged uniformly distributed in a circumferential direction U of base disc 2. For example, at least two of slot-shaped recesses 3 can extend along the common circle.

In addition, the plurality of slot-shaped recesses 3 can be arranged concentrically with respect to axis of rotation X, as illustrated in FIG. 2A. Consequently, the plurality of slot-shaped recesses 3 can be arranged concentrically in the common circle around axis of rotation X of base disc 2 and with respect to axis of rotation X but is not limited to this combination.

FIG. 2B shows a diagrammatic front view of a rotor disc device 1 for repelling grinding media K for an agitator system 10 according to a further example of embodiment of the invention, wherein the plurality of slot-shaped recesses 3 are aligned in parallel.

Rotor disc device 1 has essentially the same features as in FIG. 2A. In contrast with FIG. 2A, the plurality of slot-shaped recesses 3 are, by way of example, aligned parallel to each other in this case. Slot-shaped recesses 3 can be arranged in parallel at a uniform distance from each other.

FIG. 2C shows a diagrammatic front view of a rotor disc device 1 for repelling grinding media K for an agitator system 10 according to a further example of embodiment of the invention, wherein the plurality of slot-shaped recesses 3 are aligned in the radial direction.

Rotor disc device 1 has essentially the same features as in FIG. 2A. In contrast with FIG. 2A, the plurality of slot-shaped recesses 3 are each aligned, by way of example, in a radial direction of base disc 2. This means that the plurality of slot-shaped recesses 3 can each extend in the radial direction of base disc 2. Moreover, at least two of the plurality of slot-shaped recesses 3 can be arranged sequentially in the radial direction and extend in the radial direction.

The plurality of slot-shaped recesses 3 can also be arranged in a common circle around axis of rotation X. Furthermore, the plurality of slot-shaped recesses 3 can be arranged uniformly distributed on the common circle.

FIG. 3 shows a diagrammatic sectional view of a detail of a rotor disc device 1 for repelling grinding media K for an agitator system 10 according to a further example of embodiment of the invention, wherein the plurality of slot-shaped recesses 3 widen.

Rotor disc device 1 essentially has the same features as in FIG. 2A, 2B or 2C. Optionally, the plurality of slot-shaped recesses 3 can each widen viewed in a direction of flow of the substance and/or substance mixture or to be activated, as shown in FIG. 3. The direction of flow corresponds for example to axis of rotation X of base disc 2 or stirrer shaft 12. The plurality of slot-shaped recesses 3 can each have an opening angle α in a range of about 0.1° to about 60°, preferably in a range of about 10° to about 30°.

The design of slot-shaped recesses 3 described here can be combined with all the examples of embodiment according to FIGS. 1, 2A, 2B and 2C.

The plurality of slot-shaped recesses 3 preferably have the same features, i.e. they can be designed uniformly. However, the invention is not limited to uniformly formed slot-shaped recesses 3, but individual properties of slot-shaped recesses 3 can differ from each other.

In the preceding detailed description, various features have been summarised in one or more examples to improve the stringency of the presentation. It should be clear, however, that the above description is merely of an illustrative nature, but in no way restrictive. It serves to cover all alternatives, modifications and equivalents of the various features and examples of embodiments. In view of the above description, many other examples will be immediately and directly become clear to the person skilled in the art due to his technical knowledge.

The examples of embodiment were selected and described in order to be able to present the principles underlying the invention and their possible applications in practice in the best possible way. Persons skilled in the art are thus able to modify and use the invention and its various examples of embodiment in the optimum manner in relation to the intended use. In the claims and the description, the terms “containing” and “comprising” are used as neutral linguistic terms for the corresponding terms “including”. Furthermore, the use of the term “a” should not in principle exclude a plurality of such described features and components.

1. A rotor disc device for repelling grinding media for an agitator system, the rotor disc device comprising: a base disc, which has a disc thickness and a plurality of slot-shaped recesses, wherein the plurality of slot-shaped recesses each extend along the entire disc thickness, and wherein the plurality of slot-shaped recesses each have a slot width of about 90% or less of a diameter of the grinding media to be repelled, wherein the slot width is aligned perpendicular to the disc thickness; and a form-fitting connecting means, which is firmly connected to the base disc and is designed for rotationally fixed mounting on a stirrer shaft of an agitator system.

2. The rotor disc device according to claim 1, wherein the slot width is about 50% to about 80% of the diameter of the grinding media to be repelled.

3. The rotor disc device according to claim 1, wherein the base disc has a coating for reducing wear of the rotor disc device.

4. The rotor disc device according to claim 1, wherein the form-fitting connecting means is designed as a tongue-and-groove connection which can be mounted on the stirrer shaft in a rotationally fixed manner.

5. The rotor disc device according to claim 1, wherein the plurality of slot-shaped recesses are arranged in a common circle around an axis of rotation of the base disc.

6. The rotor disc device according to claim 5, wherein the plurality of slot-shaped recesses are arranged uniformly distributed on the common circle.

7. The rotor disc device according to claim 1, wherein the plurality of slot-shaped recesses are each aligned in a radial direction of the base disc.

8. The rotor disc device according to claim 1, wherein the plurality of slot-shaped recesses are aligned parallel to each other.

9. The rotor disc device according to claim 1, wherein the plurality of slot-shaped recesses are arranged concentrically with respect to an axis of rotation of the base disc.

10. The rotor disc device according to claim 1, wherein the plurality of slot-shaped recesses each widens in a direction of flow of the substance and/or substance mixture to be activated.

11. A agitator system for the mechanical activation and/or grinding of organic and/or inorganic substances and/or mixtures of substances in chemical, pharmaceutical, food-related and/or building materials applications, the agitator system comprising: a container for receiving grinding media as well as a substance and/or substance mixture to be activated and/or to be ground; a stirrer shaft which is supported in the container and rotatable in relation to the container; and a rotor disc device according to any one of the preceding claims, wherein the form-fitting connecting means is mounted on the stirrer shaft in a rotationally fixed manner.

12. The agitator system according to claim 11, wherein the rotor disc device is arranged, viewed in a direction of flow of the substance and/or substance mixture to be activated and/or to be ground, at the last position inside the container on the stirrer shaft.

13. The agitator system according to claim 11, further comprising at least one disc-like agitator device, which is mounted on the stirrer shaft in a rotationally fixed manner with the aid of the same form-fitting connecting means as the rotor disc device.

14. The agitator system according to claim 11, wherein the tongue-and-groove connection is axially fixed with respect to the container with the aid of a spacer sleeve.

15. The agitator system according to claim 11, wherein the grinding media are essentially spherical in shape, wherein a spherical equivalent diameter of the grinding media is in the range of about 1 mm to about 15 mm.

16. The rotor disc device according to claim 2, wherein the base disc has a coating for reducing wear of the rotor disc device.

17. The rotor disc device according to claim 2, wherein the form-fitting connecting means is designed as a tongue-and-groove connection which can be mounted on the stirrer shaft in a rotationally fixed manner.

18. The rotor disc device according to claim 2, wherein the plurality of slot-shaped recesses are arranged in a common circle around an axis of rotation of the base disc.

19. The rotor disc device according to claim 2, wherein the plurality of slot-shaped recesses are each aligned in a radial direction of the base disc.

20. The rotor disc device according to claim 2, wherein the plurality of slot-shaped recesses are aligned parallel to each other.
